(19) United States
(12) Patent Application Publication
(10) Pub. No.: US 2008/0195574 A1
(43) Pub. Date: Aug. 14, 2008

(54) PRINTED DOCUMENT CONCORDANCE SEARCHING SYSTEMS AND METHODS

(76) Inventor: Stephen C. Morgana, Rochester, NY (US)

Correspondence Address: Frederick W. Gibb, III;Gibb I.P. Law Firm, LLC, Suite 304, 2568-A Riva Road, Annapolis, MD, 21401, US

(21) Appl. No.: 11/672,719

(22) Filed: Feb. 8, 2007

(51) Int. Cl. G06F 7/00; G06F 17/30

(52) U.S. Cl. 707/1; 358/1.18

(57) ABSTRACT

Embodiments herein include a method of creating an electronically searchable concordance document that identifies locations within printed publications of text search results. The method includes laying out one or more articles (that include at least some text) into a publication to create a layout for a printed publication that is to be physically printed on physical media. Since the text is electronically available at this point, the method stores the text in at least one electronic document, without needing to scan or manually enter the title, abstract, or body of the printed document. The method identifies positional locations of the text within the layout of the publication as “text concordance” to produce a searchable electronic document. Then, after or while the searchable electronic document is being created, the method prints the publication on physical media to produce a printed publication comprising the articles laid out according to the layout.

### BACKGROUND

Embodiments herein generally relate to systems that search documents and more particularly to systems and methods that allow electronic searching of content within printed documents with search results pointing to concordance locations within the printed documents to allow the user to find the location of the results within the physical document.

### SUMMARY

Embodiments herein include a method of creating an electronically searchable concordance document that identifies locations within printed publications of text search results. The method includes laying out one or more articles (that include at least some text) into a publication to create a layout for a printed publication that is to be physically printed on physical media. Since the text is electronically available at this point, the method stores the text in at least one electronic document, without needing to scan or manually enter the title, abstract, or body of the printed document.

The method identifies positional locations of the text within the layout of the publication as “text concordance” to produce a searchable electronic document. Then, after or while the searchable electronic document is being created, the method prints the publication on physical media to produce a printed publication comprising the articles laid out according to the layout.

The method can record the searchable electronic document on a portable media, a networked server, or on any other form of electronic device to which the user may have access. In one embodiment, the method can attach the portable media to the printed publication so that the user has a searchable electronic document readily available for the printed document in their possession.

In other embodiments, the method can identify the inventory of printed publications that are maintained by a user (through user input or historical tracking of printed publications that have been delivered to the user). With such inventory information that is personal to each user, the embodiments herein can limit the searchable electronic document to items that are within the user's personal inventory. In other words, this embodiment produces a limited searchable electronic document that is unique for each user and provides this customized limited searchable electronic document to different users to assist the users in searching their personally maintained libraries or printed publications.

The process of identifying the concordance of the text within the printed document causes the searchable electronic document to identify a physical location within the printed publication corresponding to a text item produced by a search of the searchable electronic document. This provides the user with the concordance information (physical printed location) for each text term returned in response to a user query of the searchable electronic document. In other words, the concordance information identifies the location(s) within the printed publication where any specific word, phrase, etc. appears in the printed publication, relative to the numbering scheme of the printed publication (e.g., page number of the printed publication; line number of the printed publication; column number of the printed publication; paragraph number of the printed publication; top, bottom, left, right, center designation of any page of the printed publication; etc.; or any combination of the foregoing).

Further, the embodiments herein are not limited to information of a single printed publication. To the contrary, the method can store additional text from a plurality of additional publications in the electronic document and link additional text concordance for the plurality of additional publications to the additional text to make the searchable electronic document comprise information relating to a plurality of publications.

Embodiments herein also comprise a system that uses one or more computers. In the system, there is at least one layout editor running on one or more of the computers. The layout editor is adapted to receive user input to lay out the one or more articles (that include text) into the publication to create a layout for the publication. The layout comprises positions for graphic items and the text on pages of the printed publication. The layout editor can be an automated layout generator or a manual layout generator.

The system also uses electronic memory (that can be included within one or more of the computers, or separate therefrom) that is operatively connected to the layout editor. The electronic memory is adapted to store the text in at least one electronic document. The electronic memory can store additional text from a plurality of additional publications in the electronic document.

The system includes a concordance identifier running on one or more of the computers. The concordance identifier is operatively connected to the layout editor. The concordance identifier is adapted to identify positional locations of the text within the layout of the publication as “text concordance.” The concordance identifier is further adapted to cause the searchable electronic document to identify a physical location within the printed publication corresponding to a text item produced by a search of the searchable electronic document. Also, the concordance identifier is further adapted to link additional text concordance for a plurality of additional publications to additional text to make the searchable electronic document comprise a plurality of publications.

The system also includes one or more (local or remote) printers that are operatively connected to one or more of the computers to print the publication. The printed publication comprises the articles laid out according to the layout. As used herein, the “printed publication” comprises a tangible object that includes markings (text) on physical sheets (printing media) that are capable of being read and/or recognized by humans. The printed publication is contrasted with an electronic document that is stored on some form of electronic media (as electronic charges, etc.) that can be read only by a machine and that must be converted into human readable text by the machine and displayed to the user by the machine on some form of electronic display device. The printed publication can comprise any type of physical hard copy item including a book, pamphlet, newspaper, magazine, etc. With embodiments herein, the printers print the publication on physical media to produce the printed publication only after (or while) creating the searchable electronic document. Therefore, the invention does not need to scan and perform optical character recognition on the printed publication or manually enter the title, abstract, or body of the printed publication.

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flow diagram illustrating an embodiment herein; and

FIG. 2 is a schematic representation of a system according to embodiment herein.

### DETAILED DESCRIPTION

Much information is still distributed in printed form, such as magazines, catalogs, newspapers and books. Manually searching through a stack of issues of a magazine for a topic of interest, or an article can be time consuming and difficult. The embodiments described herein allow publishers of printed material to create an electronic concordance for each printing that maps words in the material to the locations in the material that the words occur. Then users that have the printed material can do multiple keyword searches on their personal computer or other device to locate pages and lines of interest that can then be manually found in the material.

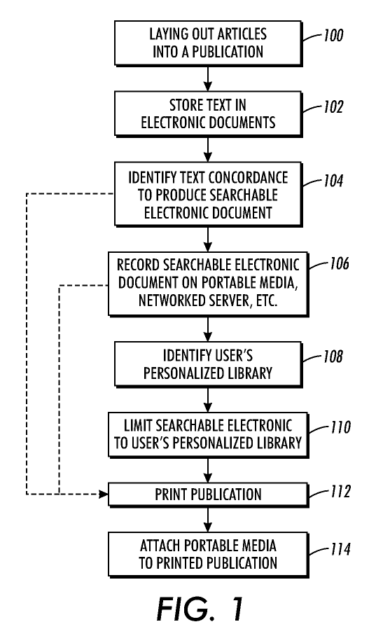

Embodiments herein include a method of creating an electronically searchable concordance document that identifies locations within printed publications of text search results. As shown in item 100 in FIG. 1, the method includes laying out one or more articles (that include at least some text) into a publication to create a layout for a printed publication that is to be physically printed on physical media. Since the text is electronically available at this point, the method stores the text in at least one electronic document in item 102, without needing to scan or manually enter the title, abstract, or body of the printed document (e.g., of a previously printed document).

The method identifies positional locations of the text within the layout of the publication as “text concordance” to produce a searchable electronic document in item 104. Then, after or while the searchable electronic document is being created, the method prints the publication on physical media (in item 112) to produce a printed publication comprising the articles laid out according to the layout.

The method can record the searchable electronic document on a portable media, a networked server, or on any other form of electronic device to which the user may have access in item 106. In one embodiment, the method can attach the portable media to the printed publication so that the user has a searchable electronic document readily available for the printed document in their possession in item 114.

In other embodiments, the method can identify the inventory of printed publications that are maintained by a user in item 108 (through user input or historical tracking of printed publications that have been delivered to the user). With such inventory information that is personal to each user, the embodiments herein can limit the searchable electronic document to items that are within the user's personal inventory in item 110. In other words, this embodiment produces a limited searchable electronic document that is unique for each user and provides this customized limited searchable electronic document to different users to assist the users in searching their personally maintained libraries or printed publications.

The process of identifying the concordance of the text within the printed document 104 causes the searchable electronic document to identify a physical location within the printed publication corresponding to a text item produced by a search of the searchable electronic document. This provides the user with the concordance information (physical printed location) for each text term returned in response to a user query of the searchable electronic document. In other words, the concordance information identifies the location(s) within the printed publication where any specific word, phrase, etc. appears in the printed publication, relative to the numbering scheme of the printed publication (e.g., page number of the printed publication; line number of the printed publication; column number of the printed publication; paragraph number of the printed publication; top, bottom, left, right, center designation of any page of the printed publication; etc.; or any combination of the foregoing).

Further, the embodiments herein are not limited to information of a single printed publication. To the contrary, the method can store additional text from a plurality of additional publications in the electronic document (102) and link additional text concordance for the plurality of additional publications to the additional text (104) to make the searchable electronic document comprise information relating to a plurality of publications.

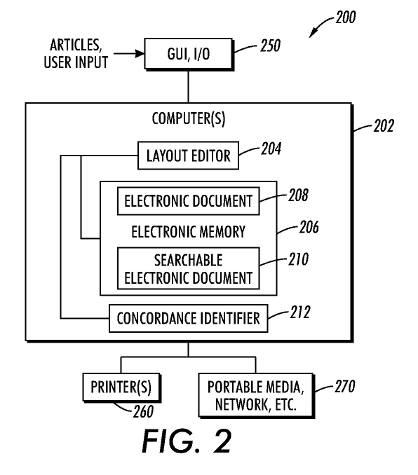

As shown in FIG. 2, embodiments herein also comprise a system 200 that uses one or more computers 202. Computers are readily available devices produced by manufactures such as International Business Machines Corporation, Armonk N.Y., USA and Apple Computer Co., Cupertino Calif., USA. Such computers commonly include input/output devices, power supplies, processors, electronic storage memories, wiring, etc., the details of which are omitted herefrom to allow the reader to focus on the salient aspects of the embodiments described herein.

In the system 200, there is at least one layout editor 204 running on one or more of the computers 202. The layout editor 204 is adapted to receive user input (through, for example, a graphic user interface and/or input/output device (GUI, I/O) 250) to lay out the one or more articles (that include text) into the publication to create a layout for the publication. The layout comprises positions for graphic items and the text on pages of the printed publication. The layout editor 204 can be an automated layout generator or a manual layout generator. Layout editors are readily available items produced by manufactures such as Corel Corporation, Ottawa, Ontario, Canada; Adobe Systems Incorporated, San Jose, Calif., USA; and Microsoft Corporation, Redmond, Wash., USA the details of which are omitted herefrom to allow the reader to focus on the salient aspects of the embodiments described herein.

The system 200 also uses electronic memory 206 (that can be included within one or more of the computers 202, or separate therefrom) that is operatively connected to the layout editor 204. The electronic memory 206 is adapted to store the text in at least one electronic document 208. The electronic memory 206 can store additional text from a plurality of additional publications in the electronic document 208.

The system 200 includes a concordance identifier 212 running on one or more of the computers 202. The concordance identifier 212 is operatively connected to the layout editor 204. The concordance identifier 212 is adapted to identify positional locations of the text within the layout of the publication as “text concordance.” The concordance identifier 212 is further adapted to create a searchable electronic document 210 that identifies a physical location within the printed publication corresponding to a text item produced by a search of the searchable electronic document 210. For details of concordance identifiers see U.S. Patent Publications 2007/0005566, 2006/0149558, and 2005/0243369 the complete disclosures of which are incorporated herein by reference.

While the electronic document 208 and the searchable electronic document 210 are illustrated as being separate, they can be combined into a single document. In other words, in some embodiments the concordance identifier 212 can actually change the electronic document 208 into a searchable electronic document 210 by adding concordance information to the electronic document 208 rather than creating a separate document. Also, the concordance identifier 212 is further adapted to link additional text concordance for additional publications to additional text, to make the searchable electronic document 210 include and relate to a plurality of publications.

The system 200 also includes one or more (local or remote) printers 260 that are operatively connected to one or more of the computers 202 to print the publication. The printed publication comprises the articles laid out according to the layout. Further, the method can record the searchable electronic document 210 on a portable media, a networked server, or on any other form of electronic device to which the user may have access (illustrated as item 270). In one embodiment, the method can attach the portable media 270 (e.g., portable flash memory device, portable disc storage, portable magnetic storage, etc.) to the printed publication so that the user has a searchable electronic document readily available for the printed document in their possession in item 114.

As used herein, the “printed publication” comprises a tangible object that includes ink, toner, etc., markings (text) on physical sheets (printing media) that are capable of being read and/or recognized by humans. The printed publication is contrasted with an electronic document 210 that is stored on some form of electronic media (as electronic charges, etc.) that can be read only by a machine and that must be converted into human readable text by the machine and displayed to the user by the machine on some form of electronic display device. The printed publication can comprise any type of physical hard copy item including a book, pamphlet, newspaper, magazine, etc. With embodiments herein the printers 260 print the publication on physical media to produce the printed publication only after (or while) creating the searchable electronic document 210. Therefore, the invention does not need to scan and perform optical character recognition on the printed publication or manually enter the title, abstract, or body of the printed publication.

The word “printer” as used herein encompasses any apparatus, such as a digital copier, bookmaking machine, facsimile machine, multi-function machine, etc. which performs a print outputting function for any purpose. The details of printers, printing engines, etc. are well-known by those ordinarily skilled in the art and are discussed in, for example, U.S. Pat. No. 6,032,004, the complete disclosure of which is fully incorporated herein by reference. Printers are readily available devices produced by manufactures such as Xerox Corporation, Stamford, Conn., USA and Hewlett Packard Company, Palo Alto, Calif., USA. Such printers commonly include input/output, power supplies, processors, media movement devices, marking devices etc., the details of which are omitted herefrom to allow the reader to focus on the salient aspects of the embodiments described herein. All foregoing embodiments are specifically applicable to electrostatographic and/or xerographic machines and/or processes.

Thus, with embodiments herein, a database of electronic concordances is created for a set of printed materials. Users are given access to the database to do multiple keyword searches of the database to locate information in the printed material that was distributed to them. The search also allows searching printed material that they do not yet own, but can purchase.

As mentioned above, the concordance can be delivered to the PC or device in a number of ways. For individual issues of the material, a memory stick, CD, etc., containing the electronic concordance can be included as an insert in the material. The user can then search an individual issue using that issue's memory stick, or can compile a local database of all issues' concordances that they have in their library. Alternatively, an online service can maintain a master database of all electronic concordances of all published material from publishers that participate in the service. Users can then do multiple keyword searches that span issues that they do not yet have in their possession, with the option of ordering issues that they need. Users may also let the online search program know which issues they own so that they can selectively search their own material or all material.

The technology used with embodiments herein is easily integrated into existing systems. Publishers of printed material already use electronic methods to produce and layout the material. Construction of electronic concordance is a low cost step in the electronic publishing process. Memory stick and memory stick reader technology already exists. Most homes have a PC that is capable of having a memory stick reader attached to a USB port, and/or also have internet access. A website providing keyword searches using embodiments herein is simple to develop and maintain as it includes a database of concordances, a simple search engine, and a user interface. The website can market back issues of printed material that are turned up in the search. The website concordance database can be augmented with text snippets from each page in the printed material to provide context to the user when searching in material that they do not have on hand.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof.

What is claimed is:

1. A method comprising:
laying out at least one article comprising text into a publication to create a layout for said publication;
storing said text in at least one electronic document;
identifying positional locations of said text within said layout of said publication as text concordance to produce a searchable electronic document; and
one of after and while creating said searchable electronic document, printing said publication on physical media to produce a printed publication comprising said at least one article laid out according to said layout.

2. The method according to claim 1, wherein said identifying of said positional location of said text causes said searchable electronic document to identify a physical location within said printed publication corresponding to a text item produced by a search of said searchable electronic document.

3. The method according to claim 1, further comprising storing additional text from a plurality of additional publications in said electronic document and identifying additional text concordance for said plurality of additional publications to said additional text to make said searchable electronic document comprise a plurality of publications.

4. The method according to claim 1, wherein said layout comprises positions for graphic items and said text on pages of said printed publication.

5. The method according to claim 1, wherein said printed publication comprises one of a book, a pamphlet, a newspaper, and a magazine.

6. A method comprising:
laying out at least one article comprising text into a publication to create a layout for said publication;
storing said text in at least one electronic document;
identifying positional locations of said text within said layout of said publication as text concordance to produce a searchable electronic document;
one of after and while creating said searchable electronic document, printing said publication on physical media to produce a printed publication comprising said at least one article laid out according to said layout;
recording said searchable electronic document on a portable media; and
attaching said portable media to said printed publication.

7. The method according to claim 6, wherein said identifying of said positional location of said text causes said searchable electronic document to identify a physical location within said printed publication corresponding to a text item produced by a search of said searchable electronic document.

8. The method according to claim 6, further comprising storing additional text from a plurality of additional publications in said electronic document and identifying additional text concordance for said plurality of additional publications to said additional text to make said searchable electronic document comprise a plurality of publications.

9. The method according to claim 6, wherein said layout comprises positions for graphic items and said text on pages of said printed publication.

10. The method according to claim 6, wherein said printed publication comprises one of a book, a pamphlet, a newspaper, and a magazine.

11. A method comprising:
laying out at least one article comprising text into a publication to create a layout for said publication;
storing said text in at least one electronic document;
identifying positional locations of said text within said layout of said publication as text concordance to produce a searchable electronic document;
one of after and while creating said searchable electronic document, printing said publication on physical media to produce a printed publication comprising said at least one article laid out according to said layout;
identifying an inventory of printed publications maintained by a user;
limiting said searchable electronic document to items within said inventory to produce a limited searchable electronic document; and
providing said limited searchable electronic document to said user.

12. The method according to claim 11, wherein said identifying of said positional location of said text causes said searchable electronic document to identify a physical location within said printed publication corresponding to a text item produced by a search of said searchable electronic document.

13. The method according to claim 11, further comprising storing additional text from a plurality of additional publications in said electronic document and identifying additional text concordance for said plurality of additional publications to said additional text to make said searchable electronic document comprise a plurality of publications.

14. The method according to claim 11, wherein said layout comprises positions for graphic items and said text on pages of said printed publication.

15. A service comprising:
laying out at least one article comprising text into a publication to create a layout for said publication;
storing said text in at least one electronic document;
identifying positional locations of said text within said layout of said publication as text concordance to produce a searchable electronic document; and
one of after and while creating said searchable electronic document, printing said publication on physical media to produce a printed publication comprising said at least one article laid out according to said layout.

16. A system comprising:
at least one computer;
at least one layout editor running on said computer, wherein said layout editor is adapted to receive user input to lay out at least one article comprising text into a publication to create a layout for said publication;
electronic memory operatively connected to said layout editor, wherein said electronic memory is adapted to store said text in at least one electronic document;
a concordance identifier running on said computer and operatively connected to said layout editor, wherein said concordance identifier is adapted to identify positional locations of said text within said layout of said publication as text concordance to produce a searchable electronic document; and
a printer operatively connected to said computer, wherein said printer is adapted to print, one of after and while creating said searchable electronic document, said publication on physical media to produce a printed publication comprising said at least one article laid out according to said layout.

17. The system according to claim 16, wherein said concordance identifier is further adapted to cause said searchable electronic document to identify a physical location within said printed publication corresponding to a text item produced by a search of said searchable electronic document.

18. The system according to claim 16, wherein said electronic memory is further adapted to store additional text from a plurality of additional publications in said electronic document and said concordance identifier is further adapted to link additional text concordance for said plurality of additional publications to said additional text to make said searchable electronic document comprise a plurality of publications.

19. The system according to claim 16, wherein said layout comprises positions for graphic items and said text on pages of said printed publication.

20. The system according to claim 16, wherein said printed publication comprises one of a book, a pamphlet, a newspaper, and a magazine.
